(19) United States
(12) Patent Application Publication
(10) Pub. No.: US 2025/0035002 A1
(43) Pub. Date: Jan. 30, 2025

(54) ASSEMBLY COMPRISING A FOIL MOUNTED ON A DISC OF A MOVING WHEEL

(71) Applicant: SAFRAN AIRCRAFT ENGINES, PARIS (FR)

(72) Inventors: Antoine GIGUET, MOISSY CRAMAYEL (FR); Nicolas Daniel DELAPORTE, MOISSY CRAMAYEL (FR); Pierre Marie MULHEIM, MOISSY CRAMAYEL (FR); Arnaud MARTINE, MOISSY CRAMAYEL (FR)

(21) Appl. No.: 18/715,268

(22) PCT Filed: Dec. 2, 2022
(86) PCT No.: PCT/FR2022/052233

§ 371 Date: Jul. 9, 2024

(30) Foreign Application Priority Data
Dec. 3, 2021 (FR) FR2112948

(51) Int. Cl. F01D 5/30

(52) U.S. Cl. CPC F01D 5/3007; F05D 2220/30; F05D 2240/30

(57) ABSTRACT

An assembly includes a disk of a moving gear of a turbomachine comprising an axis of rotation and teeth. The teeth each include a first lateral surface on one side and a second lateral surface on the other side. Slots are formed between the teeth and each include a bottom surface that connects the first lateral surface of one tooth to the second lateral surface of an adjacent tooth. A first radial surface and a second radial surface are formed on either side of the disk and delimit the slots and teeth. A shim is mounted in a slot and includes an outer surface that partly covers the first and second radial surfaces, a base in contact with the bottom surface, a first lateral arm and a second lateral arm which are connected to one another by the base.

### TECHNICAL FIELD OF THE INVENTION

The technical field of the invention is that of shims of a movable wheel for protecting turbine blades.

The present invention relates to a shim mounted to a turbine disc for protecting a movable blade and a turbomachine disc of a movable wheel. The present invention further relates to the movable wheel.

### TECHNOLOGICAL BACKGROUND OF THE INVENTION

Conventionally, a turbomachine axial turbine is comprised of a succession of axial stages (along the axis of circulation of gas flows) arranged one behind the other. Each stage includes a blade movable wheel forming the rotor and a blade nozzle forming the stator. The movable wheel is rotated facing the corresponding nozzle.

The movable wheel conventionally consists of an annular disc centred on the axis of rotation of the wheel, comprising notches in the form of a cell and a plurality of movable blades each comprising an attachment member referred to hereinafter as a blade root in the notch forming a housing.

Several types of stress are exerted in zones of contact between the root of each movable blade and the neighbouring surface of the teeth delimiting the cell- shaped notch in the disc housing this root.

There is especially fretting, i.e. contact wear, which is the consequence of repetitive friction between one piece and another, the resulting friction forces possibly generating damage to the material via various fatigue processes. This phenomenon is particularly noticeable in the case of contact between two pieces, for example of metal or CMC.

These zones are thus subject to a significant tendency to damage the material, as well as to wear of the blade root bearing surfaces which are the zones in contact with the cell-shaped surface delimiting the notch formed between the disc teeth, or even deformation of these contact zones.

In addition, the level of local stresses is very high due to the coefficient of friction at the interface between the contacting walls of the blade root and the cell surface formed by both teeth, formed by a metal/metal contact. In the following, this interface is referred to as the blade root bearing surface and the cell bearing surface.

To solve these problems, the aim is especially to enhance wear resistance of the surfaces in contact and to reduce the coefficient of friction.

To achieve this, a protective piece is generally used, which may be a consumable, formed of one or several metal shims embracing the blade root along the entire longitudinal length of the blade root bulb.

With this type of solution, the coefficient of friction is successfully reduced and the shim can be changed instead of a whole blade.

For example, document EP2042689A1 suggests resorting to an assembly with a metal shim between a blade root and a disc.

In shims of prior art, these are held in position on the blade roots by two folded tongues projecting from the base of the shim located at the bottom of the blade root against one face of the blade root.

During operation of the turbine, possible axial displacements of the shims have been noticed in some situations, which may damage the sensitive tongues following their folding/unfolding during the shim mounting phase. The mechanical strength of the shim, especially at the tongues, is too low and cannot withstand stresses generated by the blade during operation. The mechanical strength of the shim is especially related to thermal loads generated by the sequence of thermal expansions and shrinkages undergone by the blade over the operating cycles and therefore by its blade root, which transmits temperature rises and falls to the shim, which repeatedly expands and shrinks, leading to its deterioration.

In some cases, this damage can lead to cutting off and possible axial disengagement of the shims. Indeed, in these situations, once the tongues have been cut off, the shims can disengage partially or totally from the blade roots.

Disengagement of the shims no longer ensures mechanical integrity of the blade root and the turbine disc. This axial disengagement of the shim therefore leads to at least a portion of the blade root being unprotected and therefore to premature wear of the blade root at the place of the shim produced by ‘fretting’. Premature wear or a shim detected as disengaged can lead to engines being removed for replacement of the blade shims, degradation of the blade/disc interface due to greater wear without shim, degradation of the blades in the stream due to impact with the disengaged shim, and therefore an increase in maintenance time.

In some situations, the cut off tongues may also end up in an air stream and damage shock-sensitive blades located downstream of the turbine.

Also known in document EP1764480A1 is a shim whose tongue is formed by two tabs extending from the ends of the legs, joined together by a connecting piece by welding or riveting or interlocking. Such a tongue entails additional production costs and, moreover, even if the connecting piece makes it possible to increase strength of the tongue, it does not prevent one of the tabs of the tongue from breaking at the end of one of both legs. In addition, thermal stresses on the connecting piece can cause the tongue to tear.

Shims are also known, especially in document EP2042689A1 filed by the applicant, comprising a tongue folded towards the rotor rather than towards the blade, however the tongue is still likely to unfold or tear and cause wear of at least a portion of the blade. Furthermore, in this document, there is a spacer between the shim and the bottom of the disc notch. The shim therefore has its base between the spacer and a surface of the blade root. A latch is mounted retained between an upstream rim of the spacer and the blade root, so that the holding tongue is retained between the latch and the blade root, thereby preventing axial displacement of the shim relative to the blade root.

However, this solution is difficult to implement and is not always possible for reasons of overall size and mechanical strength of the blade or disc.

There is therefore a need to reduce friction between the blade root and the cell-shaped surface delimiting the notch in a simpler and/or safer way than in prior art.

### SUMMARY OF THE INVENTION

The invention offers a solution to at least one of the problems previously discussed, by allowing a shim to be positioned in a notch between two teeth of the disc and not on the blade root.

A first aspect of the invention relates to an assembly comprising:
a disc of a turbomachine movable wheel comprising:
   an axis of rotation,
   teeth each comprising, on either side, a first side surface and a second side surface,
   notches between each tooth,
   one bottom surface per notch connecting the first side surface of one tooth to the second side surface of the other neighbouring tooth forming the notch therebetween,
   a first radial surface and a second radial surface formed on either side of the disc delimiting the notches and teeth,
at least one shim mounted in a notch, comprising an outer surface partly covering the surfaces delimiting the notch, the shim comprising:
   a base in contact with the bottom surface,
   a first side leg and a second side leg connected together via the base, each of the side legs being in contact with a part of the first side surface of a tooth delimiting the notch and with a part of the second side surface of the other tooth delimiting the notch respectively,
   a first axial holding element for the shim abutting against the first radial surface to retain the shim in the notch in the axial direction of the disc of the movable wheel.

Thus, the invention makes it possible to have a shim arranged to be mounted in a notch in the disc and not on a blade root as in prior art, which makes it possible to reduce heat transmission from the blade to the shim since only the protective portion is in contact with the blade root. This reduction in the surface area in contact with the blade root with respect to prior art reduces thermal stresses of the shim and therefore reduces the risk of the holding elements tearing. The fact of also having a shim with a base extending axially along the entire length of the notch makes it possible to increase the length of the protective portion of the shim because the same includes the length of the notch in the form of a disc cell and no longer only the length of the blade root less than the length of the notch. Finally, the first axial holding element can have a larger surface area (both in length and width) than the axial holding elements of prior art, since those of the invention are not restricted by the dimensions of the blade root cross-section but by the dimensions of the disc. Indeed, on the one hand, the notch of the disc has a cross-section with a larger periphery than that of the blade root, and therefore makes it possible to form a longer axial holding element at the fold, increasing its strength, and on the other hand, the radial surface of the disc (centrally between two teeth or at the level of the tooth) also makes it possible to widen the axial element with respect to those of prior art, delimited by the cross-sectional area of the tooth which is less than that of the disc. This increased surface area makes it possible to improve their operating behaviour.

In addition to the characteristics just discussed in the preceding paragraph, the assembly according to one aspect of the invention may have one or several complementary characteristics from among those mentioned in the following paragraphs, considered individually or according to any technically possible combinations:

According to one embodiment, the shim comprises a second axial holding element of the shim abutting against the second radial surface to retain the shim in the notch in the axial direction of the disc of the movable wheel.

This allows the shim to be retained in both axial directions. In the same way as the first holding element, the fact of having the second holding element in contact with the disc makes it possible to reduce thermal stresses with respect to shims of prior art having the second holding element in contact with the root.

According to one example of this embodiment, the first axial holding element and the second axial holding element of the shim axially extend on either side of the base and are each are abutting against a central part of the first radial surface of the disc and a central part of the second radial surface respectively in order to retain the shim in the notch in both axial directions of the disc of the movable wheel.

According to another example of this embodiment, the first axial holding element and the second axial holding element for the shim each axially extend on either side of the first side leg or the second side leg and are each are abutting against a radial tooth part of the first radial surface of the disc and a radial tooth part of the second radial surface respectively, in order to retain the shim in the notch in both axial directions of the disc of the movable wheel.

According to one embodiment, the shim further comprises two other axial holding elements per side leg each axially extending on either side of the corresponding side leg, each of the other axial holding elements being abutting against a radial tooth part of the first radial surface of the disc and a radial tooth part of the second radial surface respectively, in order to retain the shim in the notch in both axial directions of the disc of the movable wheel.

According to one embodiment, the shim is compressed in the notch by comprising its side legs stressed inwardly of the shim. This makes it possible to have a shim that can be easily installed in the notch, for folding down the holding element(s) without the restriction of holding the shim in the notch.

According to one embodiment, the base of the shim comprises, on either side, a curved portion each connected to the corresponding side leg, each curved portion being concave on the side of an inner surface of the shim, and in that each side leg comprises a protective portion extending from the curved portion, in contact with a bearing surface of the corresponding tooth.

A second aspect of the invention relates to a movable wheel comprising:
an assembly according to the first aspect of the invention with or without the combination of characteristics described in the various embodiments of the preceding paragraphs, and
at least one blade, the blade comprising:
   an inner platform,
   an aerodynamic airfoil radially extending from the inner platform,
   a blade root radially extending from the platform opposite to the aerodynamic airfoil, the blade root being mounted in a notch, the root of the blade has a bulb shape comprising a bearing surface facing the inner surface of the protective portion of the shim and an axial surface extending in an axial plane, opposite to the platform,
a clearance between the inner surface at the base of the shim and the axial surface of the root.

Thus, the invention makes it possible to reduce stresses in at least one end of the blade root neck.

### BRIEF DESCRIPTION OF THE FIGURES

The figures are set forth by way of indicating and in no way limiting purposes of the invention.

FIG. 1 is a perspective view of a shim of an assembly according to a first embodiment of the invention.

FIG. 2 is a radial view of a part of an assembly according to the first embodiment, part of a disc of the assembly being represented with a shim represented in FIG. 1 mounted in a notch of the disc.

FIG. 3 is a radial view of a part of a movable wheel comprising the assembly of FIG. 2 from an opposite face.

FIG. 4 is a perspective view of a shim of an assembly according to a second embodiment of the invention.

FIG. 5 is a radial view of a part of an assembly according to the second embodiment, part of a disc of the assembly being represented with a shim represented in FIG. 1 mounted in a notch of the disc.

### DETAILED DESCRIPTION

Unless otherwise specified, a same element appearing in different figures has a single reference.

The invention is directed to an assembly comprising a shim mounted in a notch in a disc to protect friction between a root of a turbomachine rotor blade and the disc, and to a turbomachine rotor wheel comprising a rotor blade having its root inserted in the notch with such a shim between bearing surfaces of the notch and the root.

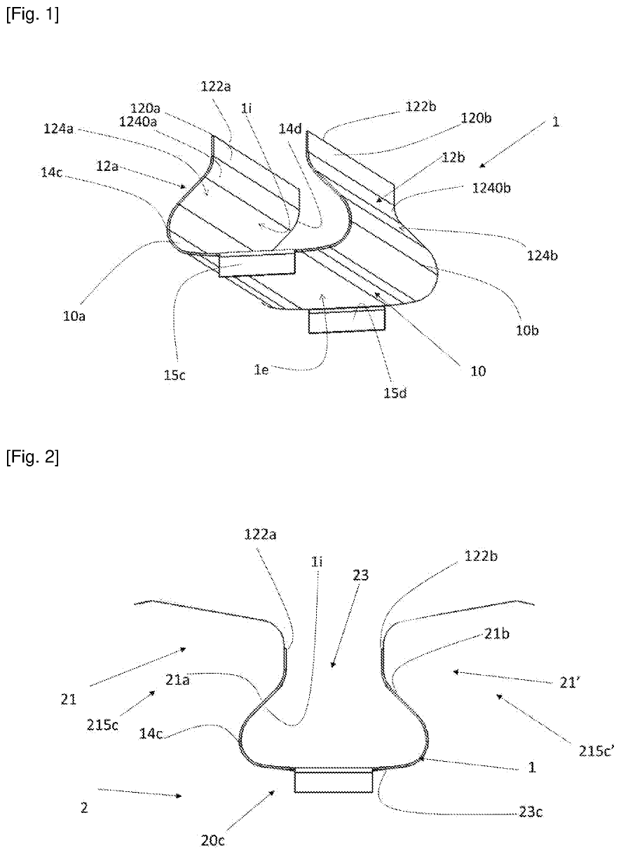

A first aspect of the invention relates to an assembly according to a first embodiment, part of which is radially represented in FIG. 2. The assembly comprises a disc 2 and a shim 1 represented alone in a perspective view in FIG. 1. The disc 2 of the turbomachine movable wheel comprises an axis of rotation not represented and, at its outer periphery, teeth of which a part of a first tooth 21, and a part of a second tooth 21′ neighbouring to the first tooth 21, are represented in FIG. 2. This FIG. 2 is a radial view of the assembly representing a first radial surface 2c of the disc 2 and a first side edge 14c of the shim 1.

Each of the teeth 21, 21′ comprises, on either side, a first side surface 21a visible on the first tooth 21 and a second side surface 21b visible on the second tooth 21′.

The disc 2 thus comprises notches 23 between each tooth 21, 21′, of which only one notch 23 is represented in FIG. 2.

The disc 2 comprises one bottom surface 23c per notch 23. This bottom surface 23c is connected to the first side surface 21a of the first tooth 21 and to the second side surface 21b of the second tooth 21′, thus delimiting the notch 23 therebetween.

The shim 1 mounted in the notch 23 covers the bottom surface 23c and a part of the two side surfaces 21a, 21b. More precisely, the shim comprises an inner surface 1i and an outer surface 1e opposite to the inner surface 1i, of which the outer surface 1e is facing or in contact with the bottom surface 23c and is in contact with a part of both side surfaces 21a, 21b.

The shim 1 visible in FIG. 1 in a perspective view thus comprises a base 10 such that the outer surface 1e at the base 10 is represented in FIG. 2 in contact with the bottom surface 23c.

The shim 1 further comprises a first side leg 12a and a second side leg 12b connected together via the base 10.

The outer surface 1e, at the first side leg 12a, is in contact with a part of the first side surface 21a of the first tooth 21 and at the second side leg 12b, is in contact with a part of the second side surface 21b of the second tooth 21′.

The parts, edge and portions of the shim on the side of the first side leg 12a include a reference with the letter ‘a’ and those on the side of the second side leg 12b include a reference with the letter ‘b’.

Each of the two side legs 12a, 12b extends from and along the base 10, i.e. are each contiguous with the base 10.

The shim 1 visible in FIG. 1 is therefore to be inserted into a notch 23 visible in FIG. 2.

The shim 1 comprises at least a first axial holding element 15c for axially holding the shim 1 abutting against the first radial surface 2c of the disc 2, to retain the shim 1 in the notch 23 in the axial direction of the disc 2 of the movable wheel.

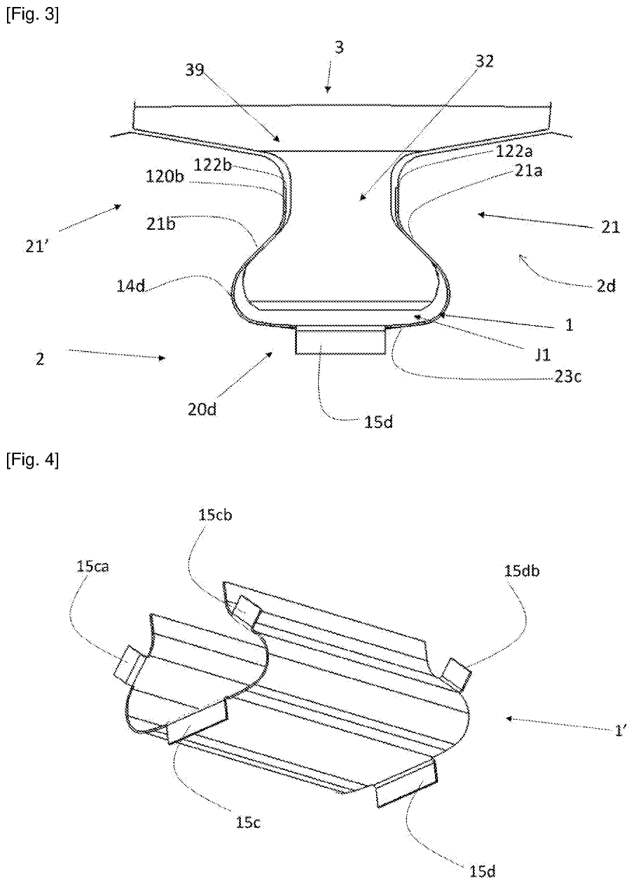

Herein, the shim 1 comprises a second axial holding element 15d axially opposite to the first axial holding element 15c, visible in FIG. 1, as well as in FIG. 3 representing a radial view of the second side edge 14d of the shim 1 and the second radial surface 2d of the disc 2. FIG. 3 represents, in particular, a second aspect of the invention, which relates to a mobile wheel, part of which is represented in FIG. 3 comprising the assembly according to the first embodiment as well as a blade 3 comprising a blade root 32 inserted into the shim 1 in the notch 23.

The shim 1 is surrounded by a bearing surface of the first tooth 21 and a bearing surface of the second tooth 21′ to protect a bearing surface of a root 31 of a movable blade 3 mounted in the notch 23. FIG. 3 represents a radial and partial view of an example of a movable wheel which comprises the assembly i.e. the disc 2 comprising notches 23 covered with shims 1 and blades 3 comprising their roots 32 inserted in notches 23 of the disc 2 and therefore at least one part inside the shim 1.

Each of the two side legs 12a, 12b comprises a longitudinal edge 122a, 122b opposite to the base 10. The first side edge 14c and the second side edge 14d, longitudinally opposite to each other, form the periphery of the shim 1 with the two longitudinal edges 122a, 112b.

In this example, each of the two side legs 12a, 12b comprises a radial planar portion 120a, 120b extending along the longitudinal edges 122a, 112b, each in contact with a top part of the corresponding tooth 21, 21′.

Each of the two side legs 12a, 12b further comprises a protective portion 124a, 124b longitudinally extending between the radial planar portion 120a, 120b and the base 10. More precisely, each protective portion 124a, 124b extends radially from the base 10 at the radial planar portion 120a, 120b towards the other protective portion 124b, 124a of the other side leg 12b.

The protective portions 124a, 124b are more tilted towards each other than the radial planar portions 120a, 120b are towards each other, i.e. the angle formed between the protective portions 124a, 124b is greater than that formed between the radial planar portions 120a, 120b, which herein in this example are parallel. By ‘parallel’ radial planar portions is meant that they each comprise a surface which extends in a plane parallel+ou−3° to the other plane in which the other surface of the other radial planar portion extends.

A fold is formed in each protective portion 124a, 124b at its delimitation with the corresponding radial planar portion 120a, 120b. In particular, each protective portion 124a, 124b comprises a curved portion 1240a, 1240b (referred to in FIG. 2) having a longitudinal axis outside the shim 1 connected to the radial planar portion 120a, 120b.

Each protective portion 124a, 124b is to protect the root 32 of the blade 3, in particular to be sandwiched between a bearing surface of the root 32 of the blade 3 and a bearing surface of the tooth 21, 21′.

Finally, in this embodiment, the base 10 comprises two curved portions 10a, 10b opposite to each other, the axis of each of which longitudinally extends on the side of the inner surface 1i, each of the two curved portions 10a, 10b being connected to the protective portion 124a, 124b of the corresponding side leg 12a, 12b.

As can be seen in FIGS. 2 and 3, in this example the shim 1 is mounted in the notch 23 with its entire outer surface 1e in contact with the disc 2, but in reality part of this surface may be in contact with the disc 2, including at least a part at the base 10 and two parts which are each at the corresponding protective portion 124a, 124b in contact with the bearing surface of the side surface 21a, 21b of the corresponding tooth 21,21′.

As can be seen in FIG. 3, the inner surface 1i comprises only its parts at each protective portion 124a, 124b in contact with the root 32 of the blades 3, in particular in contact with the bearing surfaces of the root 23 of the blades 3.

The movable wheel thus comprises a clearance J1 between the inner surface 1i at the base 10 of the shim 1 and the axial surface 32c of the blade root 32.

In addition, in this example a clearance can also be seen between the inner surface 1i at the radial planar portions 120a, 120b of the shim 1 and a restricted cross-sectional area of the root 32 adjoining and extending from the platform 39 towards a main bulb shape of the root 32. The restricted cross-sectional area of the root 32 is therefore located between the bearing surfaces and the platform. In this example, the restricted cross-sectional area of the leg 32 comprises planar surfaces.

The main bulb shape of the base 32 comprises the bearing surfaces sandwiching the protective portions 124a, 124b of the shim 1 with the disc 2.

The shim 1 is compressed in the notch 23 by comprising its side legs 12a, 12b stressed inwardly of the shim 1.

In this first embodiment, the first axial holding element 15c and the second axial holding element 15d each longitudinally extend on either side of the base 10, i.e. extend respectively from the first side edge 14c and second side edge 14d at the base. The first and second axial holding elements 15c, 15d are each bent by abutting against a central part 20c of the first radial surface 2c of the disc 2 and a central part 20d of the second radial surface 2d respectively to retain the shim 1 in the notch 23 in both axial directions of the disc 2 of the mobile wheel.

Of course, these axial holding elements could extend from the first and second side edges 14c, 14d.

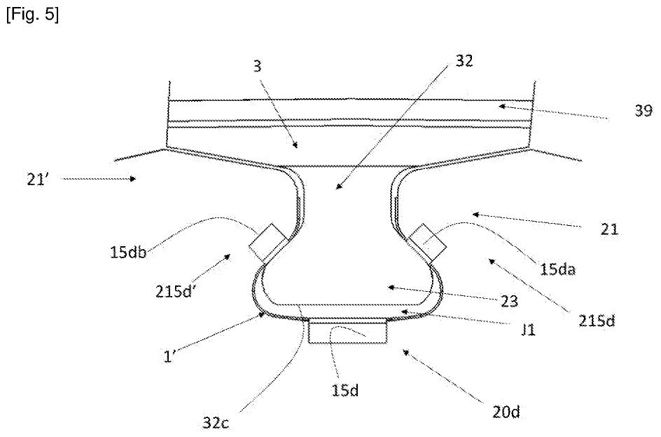

FIG. 5 represents a radial view of a part of a movable wheel comprising an assembly according to a second embodiment.

The assembly according to the second embodiment is identical to the assembly according to the first embodiment except for the shim 1′ represented in a perspective view in FIG. 4.

The shim 1′ of this assembly according to the second embodiment is identical to the shim 1 of the assembly of the first embodiment except that this shim 1′ also comprises other axial holding elements 15ac, 15bc, 15ad, 15bd, herein in this example there are four in number. In this example of this second embodiment, the shim thus comprises two other axial holding elements 15ac, 15bc, 15ad, 15bd per side leg 12a, 12b.

Each axial holding element 15c, 15d, 15ac, 15bc, 15ad, 15bd is in contact with the corresponding first and second radial surface 2c, 2d. The third and fourth axial holding elements 15ac, 15bc extending from the first and second side legs 12a, 12b respectively from the first side edge 14c, are each in contact with a radial tooth part 215c, 215c′ respectively (not visible in FIG. 5, but referenced in FIG. 2) of the first radial surface 2c of the disc 2. The fifth and sixth axial holding elements 15ad, 15bd extending from the first and second side legs 12a, 12b respectively from the second side edge 14d, are each in contact with a radial tooth part 215d, 215d′ respectively, visible in FIG. 5. Each radial tooth part delimiting 215c, 215c′, 215d, 215d′ forms a radial surface of the tooth 21.

In these two examples, the shim 1 is symmetrical. The shim 1 therefore comprises in this example two axial holding elements 15ac, 15bc on the side of the first side edge 14c and two other axial holding elements 15ad, 15bd on the side of the second side edge 14d symmetrically and the axial holding elements 15c, 15 are located at the centre of the first and second side edges 14c, 14d.

In FIGS. 1 and 4, in both embodiments, the axial holding elements 15c, 15d, 15ac, 15bc, 15ad, 15bd are represented folded. Before being mounted in the notch 23, each axial holding element 15c, 15d, 15ac, 15bc, 15ad, 15bd, can extend as an extension of the base 10 or of the side legs 12a 12b. Each axial holding element 15ac, 15bc, 15ad, 15bd, thus each forms a tongue abutting against a first and second radial surface 2c, 2d of the disc 2 as represented in FIGS. 2, 3 and 5.

Thus, by virtue of mounting the shims 1 each in a dedicated notch 23 of the disc 2, it is possible to increase the life time of the blades 3 and the shims 1.

1. An assembly comprising:
a disc of a turbomachine movable wheel comprising:
an axis of rotation,
teeth each comprising, on either side, a first side surface and a second side surface
notches between each tooth,
one bottom surface per notch connecting the first side surface of one tooth to the second side surface of the other neighbouring tooth forming the notch therebetween,
a first radial surface and a second radial surface formed on either side of the disc delimiting the notches and teeth,
at least one shim mounted in a notch, comprising an outer surface partly covering the surfaces delimiting the notch, the shim comprising:
a base in contact with the bottom surface,
a first side leg and a second side leg connected together via the base, each of the side legs being in contact with a part of the first side surface of a tooth delimiting the notch and with a part of the second side surface of the other tooth delimiting the notch respectively,
a first axial holding element for the shim abutting against the first radial surface to retain the shim in the notch in the axial direction of the disc of the movable wheel.

2. The assembly according to claim 1, wherein the shim comprises a second axial holding element of the shim abutting against the second radial surface to retain the shim in the notch in the axial direction of the disc of the movable wheel.

3. The assembly according to claim 2, wherein the first axial holding element and the second axial holding element of the shim axially extend on either side of the base and each are abutting against a central part of the first radial surface of the disc and a central part of the second intermediate radial surface respectively to retain the shim in the notch in both axial directions of the disc of the movable wheel.

4. The assembly according to claim 1, wherein the shim further comprises two other axial holding elements per side leg each axially extending on either side of the corresponding side leg, each of the other axial holding elements abutting respectively against a radial tooth part of the first radial surface of the disc and a radial tooth part of the second radial surface, to retain the shim in the notch in both axial directions of the disc of the movable wheel.

5. The assembly according to claim 2, wherein the first axial holding element and the second axial holding element of the shim each axially extend on either side of the first side leg or the second side leg and each are abutting against a radial tooth part of the first radial surface of the disc and a radial tooth part of the second radial surface respectively, to retain the shim in the notch in both axial directions of the disc of the movable wheel.

6. The assembly according to claim 1, wherein the shim is compressed in the notch by comprising its side legs stressed inwardly of the shim.

7. The assembly according to claim 1, wherein the base of the shim comprises on either side a curved portion each connected to the corresponding side leg, each curved portion being concave on the side of an inner surface of the shim, and in that each side leg comprises a protective portion extending from the curved portion, in contact with a bearing surface of the corresponding tooth.

8. A movable wheel comprising an assembly according to claim 1 and at least one blade, the blade comprising:
an inner platform
an aerodynamic airfoil radially extending from the inner platform,
a blade root radially extending from the platform opposite to the aerodynamic airfoil, the blade root being mounted in a notch, the root of the blade has a bulb shape, comprising a bearing surface facing the inner surface of the protective portion of the shim and an axial surface extending in an axial plane opposite to the platform
a clearance between the inner surface at the base of the shim and the axial surface of the root.
